(19) United States
(12) Patent Application Publication
(10) Pub. No.: US 2006/0202957 A1
(43) Pub. Date: Sep. 14, 2006

(54) Wireless mouse

(76) Inventor: Yuan-Jung Chang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/073,663

(22) Filed: Mar. 8, 2005

(51) Int. Cl. G09G 5/08

(52) U.S. Cl. 345/163

(57) ABSTRACT

A wireless mouse for sending an operation signal to a receptor includes a housing having a pivot portion disposed at a rear thereof; a circuit board disposed in the housing; a battery holder suspended over the housing, and having a battery cavity and a receptor cavity; and a keystroke lid having left and right keys exposed at the laterally external sides thereof, and including a pivot body disposed at a rear thereof to mate with the pivot portion of the housing for easy operation.

### BACKGROUND OF THE INVENTION

1. Field of the Invention

The present invention relates to a wireless mouse, and particularly relates to a wireless mouse in which the batteries can be easily changed and objects are received inside the mouse housing.

2. Description of Related Art

For ease of use, wireless electronic products, such as wireless mice and wireless keyboards, have evolved from conventional electronic products with cords or wires.

Taking the wireless mouse as an example, a transmitter is disposed inside the wireless mouse, and a receiver is arranged inside a computer for detecting signals from the transmitter. The computer carries out the actions that correspond to the transmitted signals. In fact, a wireless mouse's function and operation are the same as a conventional mouse with wires; the only difference there between being the connection manner.

However, some disadvantages in the conventional wireless mouse still need to be overcome:

1. Batteries are necessary for a conventional wireless mouse. It's thereof depends on at least one screw secured between the upper and lower housings. Moreover, there are other orientation mechanisms disposed between the upper and lower housings. If the upper and lower housings are assembled to each other after the batteries are placed in the predetermined place, it is difficult to mate them to each other, as their correct orientation is hard to establish visually.

2. The receptor of the conventional wireless mouse is movable. Because the two parts are separated from each other, the frequency of unexpected loss or breaking of the receptor increase.

Hence, an improvement over the prior art is required to overcome the disadvantages thereof.

### SUMMARY OF THE INVENTION

A wireless mouse that is easily opened and closed so that its batteries can be changed quickly. Moreover, after opening the wireless mouse, a receptor can be received therein; therefore, a one-piece movable device can be operated, and the receptor can be protected from cracking.

A wireless mouse for sending an operation signal to a receptor includes: a housing having a pivot portion disposed at a rear thereof; a circuit board disposed in the housing; a battery holder suspended over the housing, and having a battery cavity and a receptor cavity; and a keystroke lid having left and right keys exposed at the laterally external sides thereof, and including a pivot body disposed at a rear thereof to mate with the pivot portion of the housing for easy operation.

To provide a further understanding of the invention, the following detailed description illustrates embodiments and examples of the invention. Examples of the more important features of the invention have thus been summarized rather broadly in order that the detailed description thereof that follows may be better understood, and in order that the contributions to the art may be appreciated. There are, of course, additional features of the invention that will be described hereinafter which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a perspective view of a wireless mouse according to the present invention;

FIG. 2 is a side view of the wireless mouse according to the present invention;

FIG. 3 is a perspective view of the wireless mouse with batteries and a receptor according to the present invention; and

FIG. 4 is a perspective view of the wireless mouse according to the present invention.

### DETAILED DESCRIPTION OF PREFERRED EMBODIMENTS

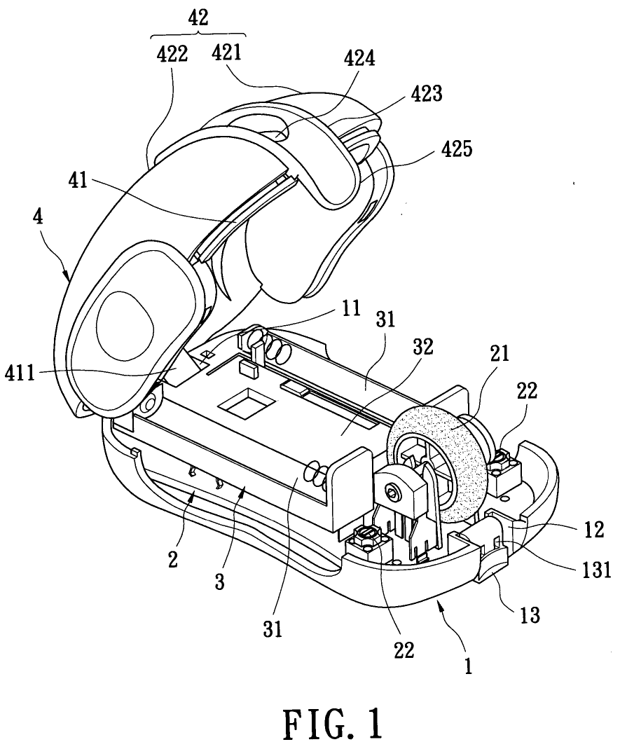

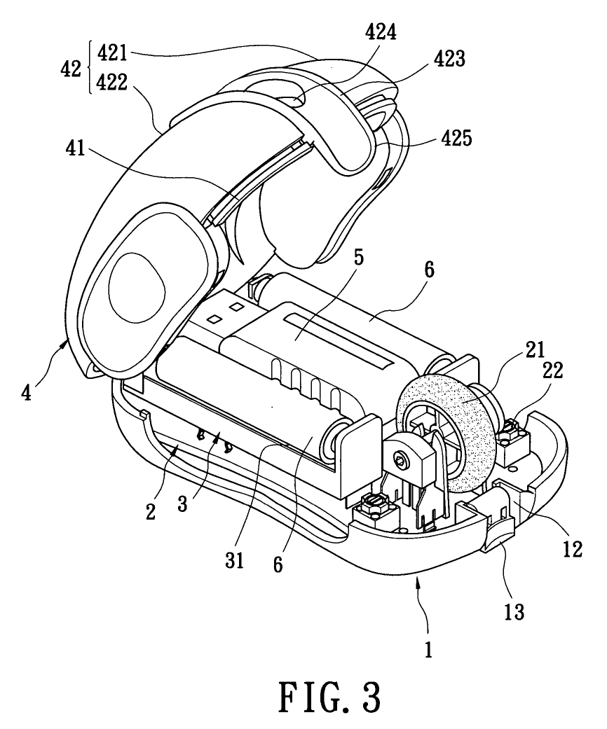

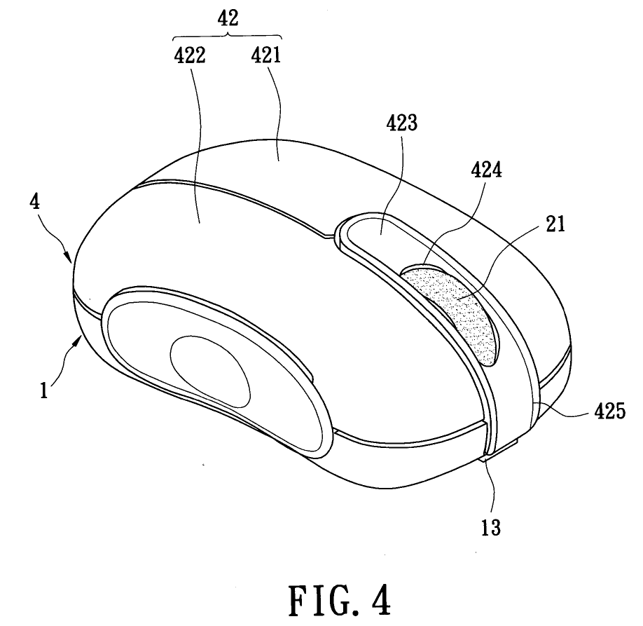

With respect to FIGS. 1 to 4, a wireless mouse according to the present invention can send an operation signal to a receptor 5. The receptor 5 electrically connects with a computer (not shown), which is enabled to receive the operation signal and execute actions corresponding to the operation signal. The wireless mouse includes a housing 1, a circuit board 2, a battery holder 3; and a keystroke lid 4 having left and right keys 41 and 42.

The housing 1 has a pivot portion 11 disposed at a rear thereof, a concave portion 12 formed at a front thereof, and a resilient member 13 extending from an inner edge of the concave portion 12. The resilient member 13 has a plurality of buckle portions 131.

The circuit board 2 is disposed inside the housing 1, and includes a rolling wheel 21 and a pair of pushbuttons 22 arranged at a front thereof. The pushbuttons 22 are used for being pressed by the left and right keys. The rolling wheel 21 and the pushbuttons 22 electrically connect the circuit board 2.

The battery holder 3 is arranged to the housing 1 via the circuit board 2, so as to be suspended over the housing 1, and the circuit board 2 is installed between the housing 1 and the circuit board 2 so that the battery holder 3 is electrically connected with the circuit board 2. The battery holder 3 includes a battery cavity 31, and a receptor cavity 32 receiving the receptor 5.

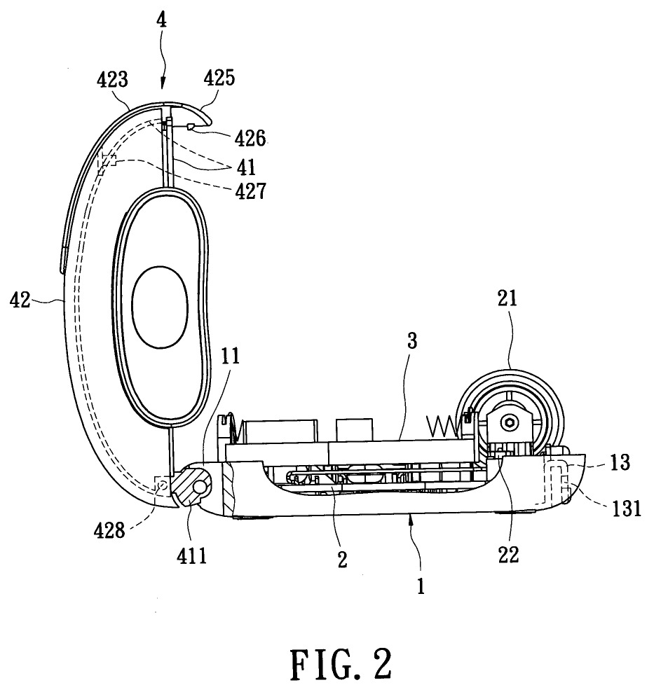

The keystroke lid 4 includes an internal shell 41 and an external shell 42 disposed outside the internal shell 41. The internal shell 41 includes a pivot body 411 disposed at a rear thereof in order to mate with the pivot portion 11 of the housing 1 for easy operation. The external shell 42, made with the left and right keys 421 and 422 connects with the internal shell 42 via a connection portion 428 (in FIG. 2) by the rear thereof. In sum, the left and right keys 421 and 422 assembly to each other to form the external shell 42.

The internal shell 41 includes a middle member 423 arranged between the left and right keys 421 and 422, and the middle member 423 has an opening 424 so that the rolling wheel 21 is exposed out.

The middle member 423 includes a projection portion 425 extending therefrom to engage the keystroke lid 4 to the housing 1. The projection portion 425 includes a plurality of buckle bodies 426 disposed thereon for corresponding to the buckle portions 131. Thus, the keystroke lid 4 and the housing 1 clamp onto each other. The resilient member 13 can be pushed to release the clamp situation and lift the keystroke lid 4.

The left and right keys 421 and 422 have a protruding member 427 extending from an inner side thereof and relative to the corresponding pushbutton 22, thus, each of the keys 421 and 422 contact the corresponding pushbutton 22 when they are pushed. The bottom of the wireless mouse includes further circuits and structures, which are acknowledged by those skilled in the art, and descriptions will be omitted.

When a battery 6 is changed or received inside the receptor 5, the resilient member 13 of the housing 1 is released easily, the lid 4 is lifted, and the battery 6 can be placed in the battery cavity 31 or the receptor 5 can be placed in the reception cavity 32. Two batteries are placed in the battery cavity 31, and the receptor cavity 32 is disposed between the two battery cavities 31. The reception manner is not restricted in the present invention, for example, the receptor 5 reposes inside the receptor cavity 32, or the receptor 5 lies on the side in the receptor cavity 32 to further save space.

Due to the characterized structure, the wireless mouse can be opened or closed easily by the lid 4 and housing 1 without the use of screws and alignments, so that the battery can be exchanged rapidly and easily without trouble.

Furthermore, the wireless mouse can further receive the receptor 5 therein as a one-piece member, which is easy to move and operate, and protects the receptor 5 from impacts and damage.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A wireless mouse for sending an operation signal to a receptor, comprising:
a housing having a pivot, portion disposed at a rear thereof;
a circuit board disposed in the housing;
a battery holder suspended over the housing, and having a battery cavity and a receptor cavity; and
a keystroke lid having left and right keys exposed at the laterally external sides thereof, and including a pivot body disposed at a rear thereof to mate with the pivot portion of the housing for easy operation.

2. The wireless mouse as claimed in claim 1, wherein the circuit board includes a rolling wheel disposed at a front thereof, the keystroke lid includes a middle member arranged between the left and right keys, and the middle member has an opening so that the rolling wheel is exposed out.

3. The wireless mouse as claimed in claim 2, wherein the middle member includes a projection portion extending therefrom and a buckle body disposed on the projection portion; the housing has a concave portion relating to the projection portion and a buckle portion formed thereon corresponding to the buckle body.

4. The wireless mouse as claimed in claim 3, wherein the housing has a resilient member disposed at an inner edge of the concave portion, and the buckle portion is formed on the resilient member.

5. The wireless mouse as claimed in claim 1, wherein the circuit board has a pair of pushbuttons arranged at a front thereof, and the left and right keys have a protruding member extending from an inner side thereof and relative to the corresponding pushbutton.

6. The wireless mouse as claimed in claim 1, wherein the quantity of the battery cavity is two, and the receptor cavity is disposed between the two battery cavities.

7. The wireless mouse as claimed in claim 1, wherein the receptor is disposed inside the receptor cavity.

8. The wireless mouse as claimed in claim 1, wherein the receptor lies on the side in the receptor cavity.

9. The wireless mouse as claimed in claim 1, wherein the keystroke lid includes an external shell and an internal shell, the external shell is made with the left and right keys, the pivot body is formed at a rear of the internal shell, and the external shell connects with the internal shell via a rear thereof, and the external shell is disposed outside the internal shell.

10. The wireless mouse as claimed in claim 9, wherein the circuit board has a rolling wheel disposed at a front thereof, the internal shell includes a middle member arranged between the left and right keys, and the middle member has an opening so that the rolling wheel is exposed out.
